(19) United States
(12) Patent Application Publication
(10) Pub. No.: US 2017/0297154 A1
(43) Pub. Date: Oct. 19, 2017

(54) DEVICE FOR CLAMPING AN UNPROCESSED PART TO BE MACHINED

(71) Applicant: STELIA AEROSPACE, Rochefort (FR)

(72) Inventors: Patrick Raballand, La Baule (FR); Mael Provin, Saint Lyphard (FR)

(21) Appl. No.: 15/514,518

(22) PCT Filed: Sep. 17, 2015
(86) PCT No.: PCT/FR2015/052492

§ 371 Date: Jun. 16, 2017

(30) Foreign Application Priority Data
Sep. 26, 2014 (FR) 1459118

(51) Int. Cl. B23Q 3/06; B64F 5/10

(52) U.S. Cl. CPC B23Q 3/065; B64F 5/10

(57) ABSTRACT

The invention relates to a device for clamping a blank part (10) to be machined, characterised in that it comprises a frame (20); means (21, 22, 23) for supporting the part to be machined; means (30, 31) for tightening said part (10) to be machined suitable for tightening said part (10) to be machined; controlled locking means (40, 41) with at least two states of said tightening means (30, 31), a locked state in which said tightening means (30, 31) are immobilised relative to the frame (20), and an unlocked state in which said tightening means (30, 31) are free to move relative to the frame (20), while keeping said part (10) to be machined tightened.

### 1. TECHNICAL FIELD OF THE INVENTION

The field of the invention is the putting and holding in position of blank parts to be machined. The invention relates more particularly to a device for clamping a part to be machined, notably a part of a portion of the fuselage of an aircraft.

### 2. TECHNOLOGICAL BACKGROUND

The machining of a mechanical part consists in removing material from a mechanical blank part in order to obtain a finished mechanical part, referred to throughout this document by the terms target part or finished part.

Said target part is defined by a shape and dimensions predetermined to within the tolerances. The machining operations use a digitally controlled machine tool of which the function is to move a cutting tool along the blank part following a fixed trajectory in order to remove material from the blank part so as to obtain the target part.

The precision of the machining is conditioned in particular by the precision of the operations for putting and holding the blank part in position on a machining support. Said operations consist in particular in bracing and clamping the part on the machining support. If the blank part comprises a plurality of different faces to be machined, said part must be unclamped after machining a first face, turned over, then braced and clamped again to machine a new face. In other words, the machining of a part consists in bracing and clamping the part on a first face, then actuating the cutting tool. The part must then be unclamped, repositioned on the second face to be machined, and the cutting tool must then be actuated again. Said operations must be repeated for each face of the part to be machined.

Furthermore, a machined part is subject to deformation owing to the relaxation of the residual stresses in the part. It is therefore often necessary, during the machining, to release the part from clamping in order to observe the deformations of the part resulting from the relaxation of the residual stresses in the part. Said natural deformation explains why in practice it is difficult to obtain the target part in a single pass from a blank part, in particular when the target part has very precise specifications and the material of the part to be machined has a marked tendency to deformation. It is therefore necessary to release the part from clamping so that said part can deform, to observe the deformations undergone, to redefine a machining pass in order to correct the deformations observed, to clamp the part again and to carry out a new machining pass. Said operations must be repeated until the desired finished part is obtained to predetermined acceptable tolerances.

In other words, the bracing, clamping and cutting operations of a part to be machined must be repeated in order to attain the desired target part.

Said bracing and clamping operations are long and inconvenient to implement, in particular for complex parts such as parts of an aircraft fuselage, and in particular the coamings of openings.

The inventors have therefore sought to propose a clamping device for a part to be machined that overcomes the above-mentioned drawbacks and in particular allows the machining operations to be speeded up.

### 3. OBJECTIVES OF THE INVENTION

The invention aims to provide, in at least one embodiment of the invention, a clamping device for a part to be machined which allows operations involving handling of parts to be machined to be limited.

The invention also aims to provide, in at least one embodiment of the invention, a clamping device which helps minimise the need to completely release the part while allowing relaxation of the residual stresses in the part.

The invention also aims to provide, in at least one embodiment of the invention, a clamping device which helps facilitate access to the part to be machined by a cutting tool of a machining tool.

The invention also aims to provide, in at least one embodiment of the invention, a clamping device which helps reduce the time needed to machine a part.

### 4. DISCLOSURE OF THE INVENTION

In order to do this, the invention relates to a clamping device for a blank part to be machined, characterised in that it comprises:
a frame,
means for tightening said part to be machined suitable for tightening said part to be machined,
controlled locking means with at least two states of said tightening means, a locked state in which said tightening means are immobilised relative to the frame, and an unlocked state in which said tightening means are free to move relative to the frame, while keeping said part to be machined tightened,
means for supporting the part to be machined mounted so as to be moveable relative to said frame so as to allow, when the locking means are in said unlocked state, movement of said part to be machined relative to the frame.

A clamping device according to the invention allows the part to be machined to be both held on the support means of the part and clamped by the combination of tightening means and of locking means of said tightening means. Clamping is achieved by the combination of tightening means suitable for immobilising the part to be machined relative to a first marker, said tightening means being formed of said tightening means, and of locking means of the tightening means suitable for immobilising said first marker relative to the frame. In other words, the originality of the invention lies in particular in breaking down the isostatic (or hyperstatic) clamping of the part relative to the frame into tightening the part by first means and locking said first means relative to the frame. A device according to the invention is therefore designed to be able to release the part relative to the frame, which allows the part to deform under the effect of the relaxation of the residual stresses in the part. However, the part is held by the tightening means, which allows the part to be quickly repositioned and clamped again once the residual stresses in the part have been relaxed. In other words, the tightening means, in the unlocked state of the locking means, do not impede the relaxation of the residual stresses of the part while allowing control to be maintained by quickly clamping the part again in its new position on the support means, and thus, quick and easy handling of the part once the residual stresses have been relaxed.

A device according to the invention thus helps reduce the machining time of a part by facilitating the clamping and releasing operations of the part to be machined, with the object of relaxing the residual stresses in the part.

Furthermore, according to the invention, the support means are mounted so as to be moveable relative to said frame so as to allow, when the locking means are in said unlocked state, movement of said part to be machined relative to the frame.

In other words, the support means are also mounted so as to be moveable relative to the frame so as to be able to move the part relative to the frame while keeping the part tightened by said tightening means. Said movement is only possible in the unlocked state of the locking means, that is, in a state in which the tightening means are free relative to the frame.

According to an advantageous variant, the support means mounted so as to be moveable relative to the frame are also controlled, so as to control the movement of said part to be machined relative to said frame.

Said advantageous variant allows the movement of the part relative to the frame to be controlled and therefore, for example, the ability of the cutting tool to access areas of the part that were previously inaccessible to said cutting tool owing to the previous position of the part relative to the frame to be increased.

Advantageously and according to the invention, said support means are retractable when said locking means are in said locked state, so as to be able to release the part from said support means while holding said part to be machined in position.

According to said variant, the support means are retractable and the tightening means then serve as means for holding the part to be machined. As the support means are retractable, access to the part is facilitated.

During movement of the part to be machined (either by unlocking the locking means, or by moving the support means and/or the tightening means), the precise position of the part relative to the frame can be recovered by means for tracing the shape of the part to be machined or by video detection means of the part to be machined. Said shape-tracing means or said video means are advantageously connected to a control and processing unit which controls a machining tool.

Advantageously and according to the invention, said support means are designed to allow the part to be machined to be held vertically so as to free at least two opposite faces of the part.

The invention also relates to a machining tool comprising at least one cutting tool and one clamping device according to the invention.

The invention also relates to a clamping device for a part to be machined and a machining tool, characterised in combination by some or all of the features mentioned above or below.

### 5. LIST OF FIGURES

Other objects, features and advantages of the invention will become apparent on reading the following description which is given solely on a non-limiting basis and which refers to the accompanying drawings, in which:

FIGS. 1a, 1b, 1c, 1d and 1e are diagrammatic views of different machining steps for a blank part using a clamping device of the prior art,
FIGS. 2a, 2b, 2c, and 2d are diagrammatic views of different machining steps for a blank part using a clamping device according to an embodiment of the invention,
FIGS. 3a, 3b, 3c, and 3d are diagrammatic views of different machining steps for a blank part using a clamping device according to another embodiment of the invention.

### 6. DETAILED DESCRIPTION OF EMBODIMENTS OF THE INVENTION

For the purposes of illustration and clarity, scales and proportions are not strictly adhered to in the figures.

FIGS. 1a, 1b, 1c, 1d and 1e show the different machining steps for the two opposite faces of a mechanical part 10 using a clamping device of the prior art. Said clamping device of the prior art comprises a planar support 11 on which the part 10 is placed. Said clamping device also comprises means 12, 13, 14, 15 for clamping the part suitable for holding the part 10 to be machined such that it is immobile relative to the support 11. Said clamping means 12, 13, 14, 15 are screws, for example, which pass through the ends of the part 10 to be machined and become fixed in the support 11. A cutting tool 8 is positioned so as to interfere with a first face of the part 10 to be machined and remove material. In all the figures, the dotted lines show diagrammatically the trajectory of the cutting tool 8 as it machines the face in question.

FIG. 1b shows the same operation on the second face of the part. In order to pass from the situation in FIG. 1a to the situation in FIG. 1b, the clamping screws have been removed, part 10 has been turned over and the clamping screws have been put back in place before machining the second face.

FIG. 1c shows the part 10 released from the clamping means 12 after machining two opposite faces of the part 10. The mechanical part 10 can therefore deform under the effect of the relaxation of the residual stresses in the mechanical part 10.

Said deformation of the part necessitates a second machining pass of each of the two opposite faces of the mechanical part 10 in order to obtain the desired target part.

FIG. 1d shows the part 10 clamped by screws 13 and 14. The finish machining of a first face of the part 10 is shown. During this step, the clamping end pieces 18, 19 are cut off.

FIG. 1e shows the finish machining of the other face of part 10. In order to pass from the position in FIG. 1d to the position in FIG. 1e, as well as cutting off the clamping end pieces 18, 19, the clamping screws 12, 13, 14, 15 have been removed, the part 10 has been turned over and the clamping screws 13, 14 have been repositioned.

It is therefore clear that in order to obtain the desired finished piece, no less than four successive clampings of the part 10 are necessary and as many handlings of the part 10.

FIG. 2a, 2b, 2c et 2d show diagrammatically a clamping device according to a first embodiment of the invention during the successive machining steps of the same part 10 in order to obtain an identical finished part to that obtained at the end of the step shown in FIG. 1e.

A clamping device for the part 10 according to the invention comprises a frame 20, abutments 21, 22, 23 for supporting the mechanical part 10 to be machined, means 30, 31 for tightening the mechanical part 10 and controlled locking means 40, 41 of said tightening means 30, 31.

In this embodiment, the part 10 is held in position vertically by abutments 21, 22, 23 which serve as support means. Each longitudinal end of the part 10 is associated with tightening means and locking means specific to said end.

The tightening means 30, 31 are for example vices or cylinders suitable for keeping each respective end of the part 10 tightened.

The locking means 40, 41 are connected to the tightening means 30, 31 and are designed to immobilise said tightening means 30, 31 relative to the frame 20 in a locked state, and to release said tightening means 30, 31 relative to the frame in an unlocked state.

Said locking means are for example formed of a magnetic system suitable for inhibiting on command any movement of an element rigidly connected to the tightening means and for releasing said element in the unlocked state. According to another embodiment, said locking means are formed of cylinders of which the translational movement of the cylinder rod can be locked by an electromechanical, electropneumatic or hydraulic device.

According to the embodiment in the figures, the tightening means 30, 31 are designed to be in a first position, referred to as the open position, in which said means do not apply any tightening force to the part 10 to be machined (the position shown in FIG. 2a) and in a second position, referred to as the closed position, in which said means apply a tightening force to the part 10 to be machined in order to hold said part in position (the position shown in FIG. 2b, 2c, 2d). In the open position, an operator can house the part 10 to be machined on the support abutments 21, 22, 23. Once the part 10 is in position, the tightening means 30, 31 are switched to the closed position. The transition from the open position to the closed position may be carried out manually or by controlled means.

FIG. 2b is a view of the machining of the two faces of part 10. As can be seen, it is not necessary to release the part from clamping in order to pass from machining one face to the other, owing in particular to the fact that the part is held by the ends thereof and to the vertical position of the part. In FIG. 2b, the means 30, 31 are in the closed position and apply a tightening force to the part, and the locking means 40, 41 are in the locked position so that the tightening means 30, 31 are immobilised relative to the frame 20.

In FIG. 2c, the locking means 40, 41 have been switched to the unlocked position so as to allow spontaneous movement of the tightening means 30, 31. The part 10 remains in position on the abutments 21, 22, 23 while being able to deform under the effect of the relaxation of the residual stresses thereof.

In FIG. 2d, the locking means 40, 41 have been switched back to the locked state in order to clamp the part completely relative to the frame and to allow for a finish machining pass for counteracting the deformations of the part 10.

At the end of this step, the finished part 10 is obtained. The clamping end pieces are cut off at the end of said finishing step. It can thus be seen that to obtain the same finished part as that obtained using a clamping device of the prior art, the device according to the invention only requires two clampings of the part relative to the frame. Moreover, the operations for releasing the part are far simpler to carry out given that said operations consist simply in releasing the locking means so that the part can deform, while being kept tightened by the ends thereof.

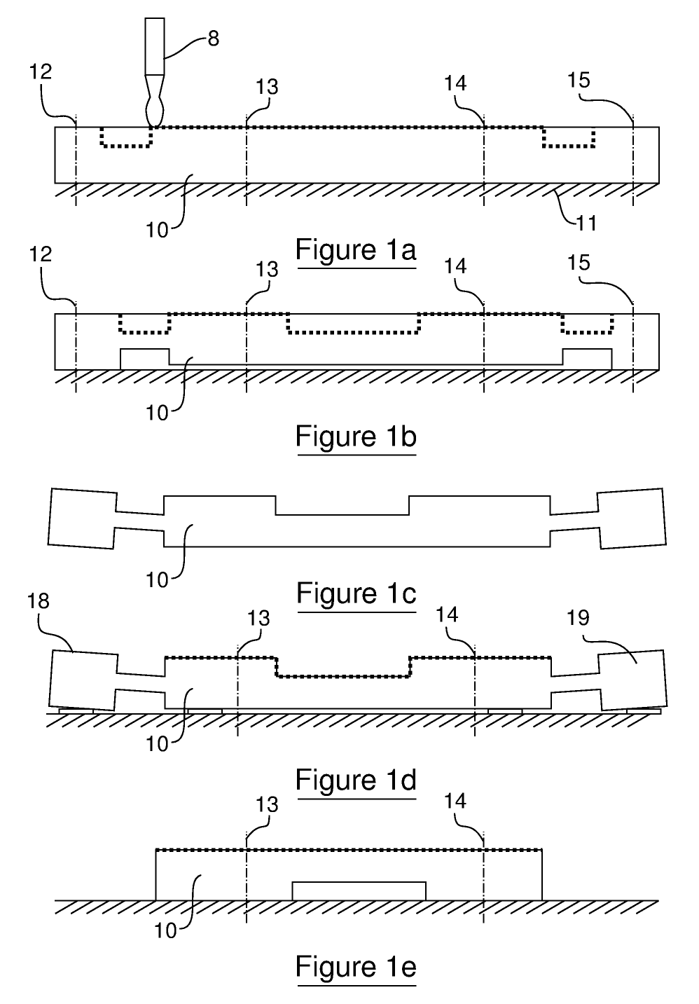

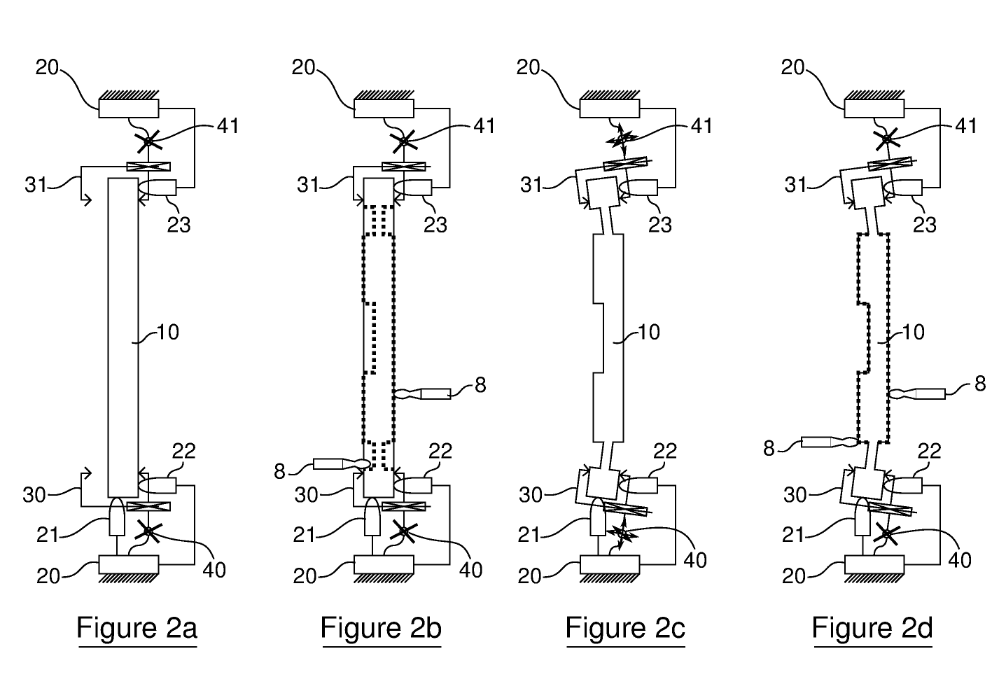

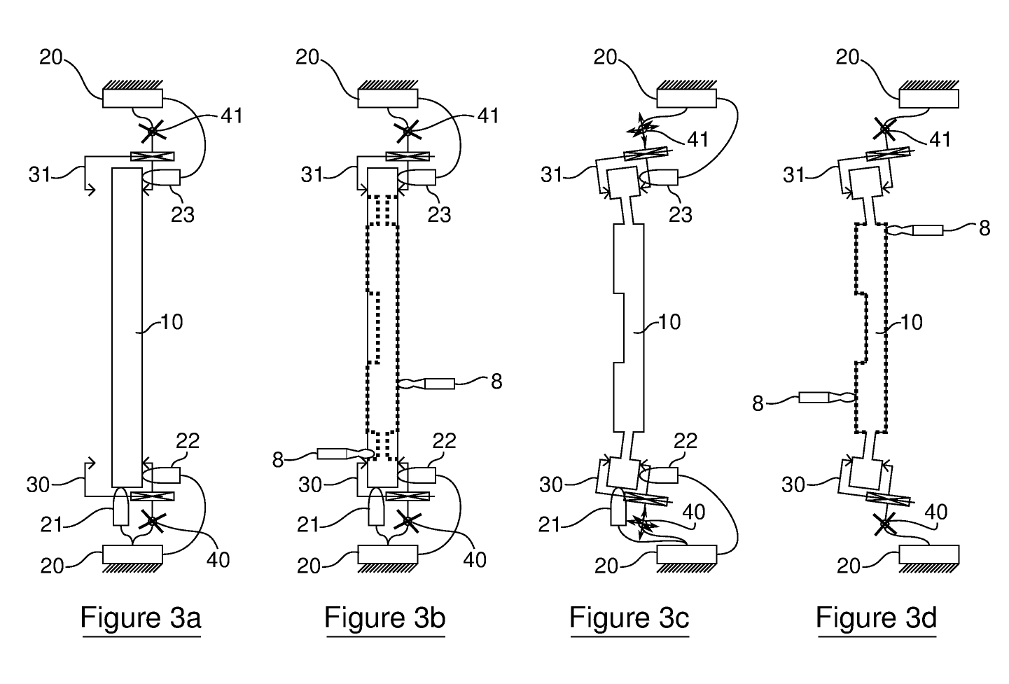

The clamping device of FIGS. 3a to 3d is identical to that of FIGS. 2a to 2d, except that the abutments 21, 22, 23 are mounted so as to be moveable relative to the frame 20.

Thus, the first two steps of the machining of the part 10 shown diagrammatically in FIGS. 3a and 3b are identical to the steps shown diagrammatically in FIGS. 2a and 2b. However, said moveable abutments 21, 22, 23 allow, as shown in FIG. 3c, the part 10 to be moved relative to the frame 20.

This allows the part to be moved relative to the frame 20 and for example to provide, as in FIG. 3c, increased accessibility for the cutting tool to the areas of the part 10 that were previously inaccessible to said cutting tool owing to the previous position of the part relative to the frame (FIG. 3b).

Said moveable abutments 21, 22, 23 are formed for example of support pins connected to mechanisms of the connecting rod type and cylinder-type actuators.

Furthermore, according to an advantageous embodiment as shown in FIG. 3d, the abutments 21, 22, 23 are also retractable so as to facilitate access to the part 10 to be machined.

The clamping end pieces are cut off at the end of said finishing step.

The invention is not limited only to the embodiments described. In particular, other types of tightening means or locking means may be used to implement the invention.

1. A device for clamping a blank part to be machined, comprising:
a frame,
a tightener tightening said part to be machined by keeping said part to be machined tightened,
a lock connected to the tightener and providing the tightener with at least two states, including a locked state in which said tightener is immobilised relative to the frame, and an unlocked state in which said tightener is free to move relative to the frame, while keeping said part to be machined tightened,
a support on which the part to be machined is mounted so as to be moveable relative to said frame so as to allow, when the lock is in said unlocked state, movement of said part to be machined relative to the frame.

2. The device according to claim 1, wherein said support is controlled so as to control the movement of said part to be machined relative to said frame.

3. The device according to claim 1 wherein said support is retractable when said lock is in said locked state, so as to be able to release the part from said support while holding said part to be machined in position.

4. The device according to claim 1, wherein said support comprises abutments on which said part to be machined can rest.

5. The device according to claim 1, wherein said support allows the part to be machined to be held vertically so as to free at least two opposite faces of the part.

6. The device according to claim 1 wherein said tightener comprises cylinders.

7. A achine tool for machining a blank part comprising at least one cutting tool wherein said tool comprises a clamping device comprising:
a frame,
a tightener tightening a part to be machined by keeping said part to be machined tightened,
a lock connected to the tightener and providing the tightener with at least two states, including a locked state in which said tightener is immobilised relative to the frame, and an unlocked state in which said tightener is free to move relative to the frame, while keeping said part to be machined tightened,
a support on which the part to be machined is mounted so as to be moveable relative to said frame so as to allow, when the lock is in said unlocked state, movement of said part to be machined relative to the frame.

8. The device according to claim 1 wherein said tightener comprises vices.

9. The machine tool according to claim 7, wherein said support is controlled so as to control the movement of said part to be machined relative to said frame.

10. The machine tool according to claim 7, wherein said support is retractable when said lock is in said locked state, so as to be able to release the part from said support while holding said part to be machined in position.

11. The machine tool according to claim 7, wherein said support comprises abutments on which said part to be machined can rest.

12. The machine tool according claim 7, wherein said support allows the part to be machined to be held vertically so as to free at least two opposite faces of the part.

13. The machine tool according to claim 7 wherein said tightener comprises cylinders.
